(19) United States
(12) Patent Application Publication
(10) Pub. No.: US 2008/0226137 A1
(43) Pub. Date: Sep. 18, 2008

(54) Metabolism- or Biochemical-Based Anti-Spoofing Biometrics Devices, Systems, and Methods

(76) Inventors: David A. Benaron, Portola Valley, CA (US); Illian H. Parachikov, Belmont, CA (US); Michael Fierro, Los Gatos, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/049,122

(22) Filed: Mar. 14, 2008

Related U.S. Application Data
(60) Provisional application No. 60/918,110, filed on Mar. 14, 2007.

(51) Int. Cl. G06K 9/00

(52) U.S. Cl. 382/115

(57) ABSTRACT

A biometric device for detecting biological tissue based upon ratiometric measurements of metabolic and/or biochemical intermediates is provided in which a radiation source (103) is electromagnetically coupled to a target region (125). A radiation sensor (155) receives emission signals (128) from the target region as a result of emitted radiation (121) interacting with the target region. A CPU (167) receives a signal from the sensor, and provides a biometric output signal based upon the presence of live, healthy tissue versus sham or dead tissue. Optionally, a conventional, non-metabolism, non-biochemical-based biometric sensor can be incorporated into the present invention, and the biometric output signal is then a result of both the metabolism- and/or biochemical based and non-metabolism non-biochemical-based biometric determinations. A method of performing this biometric analysis is also described.

### RELATED APPLICATIONS

This patent application claims the benefit of and priority to U.S. Provisional Patent Application Ser. No. 60/918,110, filed Mar. 14, 2007, entitled “Metabolism-Based Anti-Spoofing Biometrics Devices and Methods,” the entire disclosure of which is incorporated herein by reference in its entirety.

### FIELD OF THE INVENTION

The present invention relates in general to devices and methods for providing biometric measurements, for example in some embodiments is provided real-time, metabolism-based biometric measurements. More particularly in some embodiments the present invention relates to devices and methods comprising a metabolism-sensitive sensor having an electromagnetic radiation source and detector in order to perform real-time analysis that distinguishes between real and spoofed or dead tissue.

### BACKGROUND OF THE INVENTION

Biometric devices are devices used to identify people for secure access or confirmed identity. Secure identification of individuals usually involves the detection or extraction of a unique feature.

On the whole, the features used (such as employee identification cards, fingerprint sensors, written signatures) can be “spoofed” in a number of ways. In this context, the term “spoofed” most commonly means imitated in a manner to reduce the security of the identification, and more broadly suggests that a security feature is fooled or tricked. For example, a fingerprint sensor can be spoofed using a glove with a dusting of a positive-image from a real fingerprint, or by using a latex casting of a finger and fingerprint, because the dusting or cast each contain a physical reproduction of a biometric feature, without having to demonstrate whether real finger or faux-fingerprint are either alive or dead. Therefore, it remains quite easy for one skilled in the art to fool most biometric systems using precisely made, but inanimate, objects that appear similar or very similar to the target feature of the biometric screening system, in order to obtain false access to a secure system or area.

Attempts to provide secure identification with at least some degree of anti-spoofing protection are known in the art. RFID (Radio-Frequency Identification Device) tags to personnel or ID cards have been used, but these cards can be stolen or the chips duplicated. Moreover, such physical devices are not inherent characteristics of a person, which can be lost, or stolen.

In contrast, there are certain stable physical features unique to an individual which have been used as anti-spooling counter-measures. For example, retinal blood vessel patterns as described in U.S. Patent Publication no, 2005/0116810, or facial patterns obtained through video imaging as described in U.S. Patent Publication no. 2001/0026632, are very stable. However, by the very nature of the inherent stability of these features, these features can be forged by well-crafted model tissues, organs, or vessels, as they typically rely only on the physical location and orientation of certain ridges, features, or blood vessels, but not at all upon the viability of those tissues, namely whether those vessels are part of a real, live organ or human at all. An example of a physical feature sensor is the use of linear spectroscopy to: identify stable aspects of a person's chemical composition, as described in U.S. Pat. No. 6,816,605. Such fat and water content analyses are stable ratios of chemicals that can be recreated and stored in test tubes using low-sophistication mixtures of water and lard. Therefore, while these chemical features are indeed stable and reproducible, yet varying from person to person, they do not provide anti-spoofing strength against an inanimate but physically accurate mixture model created by one skilled in the art of deception. Further, such features do not change if the subject or tissue dies (such as a cut-off finger used to enter a secure area), or may unpredictably change if the person is flushed and hot, or dehydrated and cold, making the acceptable values of any test require widely varying but acceptable values

One set of features less easily spoofed are tissue characteristics created only when the test subject is real. Such transient, unimodal biometric features include body temperature, an electrical conductivity suggestive of tissue as described in U.S. Pat. No. 6,067,368, and other non-permanent physical features that can be quantitatively measured. Each of these can also easily be spoofed, however, because they are not unique features of living tissue alone, and they tend to involve just one type of measurement. As before, such temperature and electrical resistances are not secure, as they can be physically duplicated using low-sophistication heated or resistance-matched materials, respectively. Further, as these features can be altered by environmental exposure or surface wetness, such that even the true target subject may not be recognized at times, the test must have a wide range of values that it will accept as normal, or else the subject will be rejected. Such wide standards are the mark of a poorly secure test. Therefore, the ability to easily recreate these single-feature signals, combined with the wide range of normal in any given individual, virtually guarantees a fundamentally spoofable and insecure biometric marker.

What is needed in the art, and not currently available, is a highly-reliable but inherently unstable biometric measure that preferably provides one or more of: (a) a unique characteristic of a living metabolism that is (b) sufficiently unstable so as to alter rapidly and virtually irreversibly upon death or dismemberment, and that (c) is very difficult to stably and reliably reproduce outside of the living body because of the very metastable nature of the feature that requires and demands a dynamic maintenance of an energy-requiring and delicate equilibrium balance not found in model tissues. Such a system would be difficult to reproduce in a nonliving material, and has not been described in the art in an enabling manner, nor is such a system commercially available to our knowledge.

### SUMMARY OF THE INVENTION

In general, the present biometric invention provides devices and methods that provide metabolism-based or other equilibrium-based discriminations between real, living targets, and spoofed or sham target tissues. In some embodiments, devices and methods provide metabolism-based, ratiometric discrimination between real and sham tissue in an automated and highly secure and spoofing-resistant manner. In some embodiments, the present invention uses electromagnetically-metastable ratios maintained only by metabolizing tissue, and easily lost in non-living models of tissue or non-viable (dead) tissue, in order to make a secure and reliable biometric identification of real, live tissue, either as a single global or localized measurement, or even at multiple sites as an image.

The invention is based upon the recognition that all life is based upon metabolic pathways, and that the steady-state equilibrium balancing of the levels between various metabolites is tightly controlled by a flow of metablistes, nutrients, and other organic and living biochemical pathways in order to maintain life over a wide variety of metabolic states (normal, hypermetabolic, resting, hibernating, and others), conditions (normal, septic, ischemic, and others), and processes, immune muscular, cerebral, and others). This self-stabilization and equilibrium-maintenance requires energy, which is a unique sign of life not found in the vast majority of tissue-imitating models, and much more difficult to replicate for spoofing. Without this energy, such as in dead tissue or in a sham tissue, these balances rapidly shift, fail, deteriorate, or change away from the normal values found in living tissue. In fact, it is very difficult to create a stable system of multiple chemicals in a complex interconversion process in a test tube without an active feedback-looped complex balance and energy source, as is found in nearly all cellular processes but which is nearly universally absent in test tubes. Further, when a tissue dies, these complex pathways immediately cease to balance, and drive toward one extreme or the other, again in stark contrast to living tissue.

The key inventive realization here is that metabolic pathways are virtually eternally held and kept in very tightly regulated equilibrium balance in all living bodies, and that these metastable pathways lose this balance rapidly upon injury or death. In fact, these balanced reactions are a hallmark of life itself. Therefore, the presence of such balances becomes very difficult to spoof, and provides a reliable indication that the tissue is real.

Accordingly, some embodiments of the present invention provide methods and devices for discriminating between live and dead tissue using metabolic and other biochemical equilibrium pathway levels, whether to merely to detect or even image this feature. In some embodiments, the metabolic and other biochemically-influenced pathway steady-state levels or life-associated ranges as analyzed by the present invention are characterized as metastable, energy-requiring, and equilibrium-balanced. Devices of the present invention may be configured to detect the metabolic or other life-influenced biochemical pathway levels, while alternatively devices of the present invention may be configured to produce an image the metabolic and other biochemical pathway levels.

In other embodiments of the present invention, a method for discriminating between real and false tissue using metastable, energy-requiring equilibrium-balanced metabolic or other metabolic biochemical pathway levels is provided, and may provide detection or an image this feature.

In other embodiments, methods are provided to measure these metastable pathways using electromagnetic energy, such as NMR (nuclear magnetic resonance), absorbance spectroscopy, scattering or fluorescence spectroscopy, optical rotation, laser speckle spectroscopy, terahertz or microwave spectroscopy, X-ray spectroscopy, Raman spectroscopy, ESR (electron spin resonance) spectroscopy, MRI imaging, or other electromagnetic methods as may be reasonably achieved by one skilled in the art of electromagnetic detection.

In some embodiments, methods and devices are provided that provide classification and/or identification of persons by comparison to a priori knowledge. In one exemplary embodiment, spectral characteristics of a target tissue. (or tissues) is/are stored for reference in the device, or in a memory device provided with the subject such as a removable RFID badge or implantable RFID microchip, and then compared to real-time measurements. Such an implantable microchip could reasonably include circuitry to perform some of the measurements contemplated in the present invention. In another embodiment, devices may contain a record of prior acquired data of the area of the body being scanned (such that far away tissues such as liver need not be considered in the analysis of an inserted finger, while skin characteristics would be stored and provided), and this stored or provided a-priori information is then compared during real-time measurements. Additionally, in some embodiments, images and/or data of prior medical scans (such as a CT or MRI) are stored in the device and compared during real-time measurements.

In other embodiments, the device is embedded in a full system with microprocessor control, subject interface, and display, such as might be found in a kiosk-based security system, or embedded into a secure door lock or controlled-entry system, as could be designed and built by one skilled in the art of controlled entry devices.

Embodiments of the present invention provide for incorporation of the observation that electromagnetic-waves, such as light or terahertz waves, which can be made to penetrate human tissue, then be detected upon reemergence in order to allow quantitation of physiological characteristics of the tissue that indicate if the tissue is alive or dead, such as biochemical composition of physiological or metabolic intermediates, including imaging and localization of these markers, and that such information is useful.

Additionally, in some embodiments this classification of live or deal tissue then is used as a decision point upon which a response may be initiated, such as with an alarm bell, or an interlock decision may be initiated.

In summary, an embodiment of the present invention provides an electromagnetic biometric device, monitor or system for detecting and/or classifying biological tissue. Detection and/or classification of biologic tissue may be based upon ratiometric measurements of metastable metabolic or biochemical intermediates in which a light emitter is optically coupled to the tissue to be diagnosed and a light detector is optically coupled to the tissue to detect a portion of the light having passed through a portion of the tissue. A CPU receives a signal from the detector and provides an output signal. In some embodiments the output signal is an optical spectroscopic output signal that may be analyzed to determine whether the biological tissue is alive or dead. In other embodiments, the output is a secure, processed signal representing the recognition (or not) of living tissue, perhaps even recognition of a particular individual. The device may be incorporated into a more extensive security or controlled access interlock, security system, controlled entry barrier, self-standing kiosk, or other entry, access, tracking, recognition, or other system which is dependent for security upon the recognition of a person or entrant and which requires high-security that would benefit from resistance to spoofing. Methods of performing this biometric analysis are also described. The breadth of uses and advantages of the present invention are best understood by example, and by a detailed explanation of the workings of constructed apparatus. These and other advantages of the invention will become apparent when viewed in light of accompanying drawings, examples, and detailed description.

### BRIEF DESCRIPTION OF THE DRAWINGS

Advantages and embodiments of the present invention will become apparent upon reading the following detailed description and upon reference to the following figures, in which:

FIG. 1 is a schematic diagram of a monitor for identifying biological tissue intermediates in accordance with some embodiments of the present invention;

FIG. 2 shows an example of a finger on a sensor in accordance with some embodiments of the present, invention;

FIGS. 3A to 3E illustrate several alternative arrangements of a sensor in accordance with some embodiments of the present invention;

FIG. 4 is a schematic diagram illustrating an exemplary security system in accordance with one embodiment of the present invention;

FIG. 5 shows the visible and infrared light optical (electromagnetic) spectrum of six measured real and sham tissues analyzed by devices and methods of the present invention; and

FIGS. 6A and 6B show the NMR spectrum of healthy (living) tissue and freshly dead (dying) tissue, respectively, in the phosphorous spectrum.

### DETAILED DESCRIPTION OF THE INVENTION

### Definitions

For the purposes of this application, the following definitions are provided for illustration and are not intended to limit the scope of the invention.

Biometrics. A field of measurements in which the purpose is to provide an identification or recognition function based upon a person's physical or functional characteristics. Physical features include but are not limited to: height, weight, facial features, and retinal vessel pattern. Functional features include but are not limited to: electrocardiogram, voice, brain waves, blood oxygenation, and the like, that are signs of a living being, and are generally not present in inanimate or spoofed-tissue. Biometric measurements are used, for example, for security purposes such as building entrance restriction, document viewing restrictions, missile launch restrictions, personnel activity tracking and even for screening of possible terrorists at airports.

Spoofing. The act of creating a false (sham) or deceptive decoy that confuses a biometric measurement into believing that the sham decoy is the real tissue, thus bypassing the security of the biometric identification system, and corrupting the inherent recognition and/or screening function that the biometric identification was intended to provide. The effect can range from the minor (logging on to an associate's computer using their password), to major (theft of state secrets, theft of personal identifiers, e.g., identity theft), to catastrophic (terrorists bypassing airport security measures, or unauthorized launch of nuclear missiles). The terms “sham tissue” and “dead tissue” are equivalents of spoofed tissues, and can be used in the context of spoofing.

Metabolic or Biochemical Equilibrium. All living organisms involve a large amount of biochemical activity, which in turn requires energy in order to maintain these biochemical processes at the desired balance. Just as in a petroleum distillation tower, in which crude oil plus energy produces many stable distillation levels in a distillation tower, each with its own unique chemical traits in a mixture maintained only by the continued input of energy, so too does living tissue have thousands of simultaneous metabolic reactions all kept in flux, but at stable levels of the intermediates, through the input of energy. Central to this concept is that there is a metastable chemical environment that is inherently unstable in the long term, but stable in the short term with the continued input of energy which we call life. Such metastable environments are, by definition of their instability, very difficult to spoof or reproduce in any test tube environment or in artificial tissue. In fact, once a biological organism's energy source is removed (e.g., the organism dies, or a finger is removed from the body), these unstable balances immediately begin to drift from their tightly-controlled states, in many cases after only a few seconds. This signal for the control of each biological equilibrium is often the ratio of certain intermediates (ratios are the basis for chemical equilibrium of two or more intraconverting species), such that normal ratios are actively maintained in living tissue, which absolute levels can be used in other reactions (such as levels of glucose that are controlled by physiologic responses to values outside of the range of normal). These natural ratios and normal levels of biochemical or physiologic intermediates are difficult to create in a test tube, and can be virtually impossible to maintain and transport in an artificial form such as a fake finger. For example, maintaining hemoglobin at a saturation of 70% (a ratio of 0.3 parts oxyhemoglobin to 0.7 parts deoxyhemoglobin) without absorbing additional oxygen from the air, or losing oxygen to bacteria or contaminants (a ratio based measurement), or without being degrading to oxidized methemoglobin (a level based measurement), is difficult to achieve in a test tube or isolated blood sample. Further, these ratios and levels are non-existent in the vast majority of sham tissues.

Metastable. An inherently unstable state that is only maintained in actively-metabolizing tissue. Such states, and in particular ratios of certain in metabolites, rapidly degrade and change upon death, and are very difficult to create and maintain in a model system such as sham tissue. The metastable value can be a ratio of two, of more; substances, or an absolute level that is maintained during life, but which degrades or is absent in sham tissues.

Ratio-Based. Use of metabolically-stabilized or other ratios of certain parameters, such as the levels of Adenosine Triphosphate (ATP) to inorganic phosphate (Pi) in tissue. Any suitable parameter may be used which indicates the presence of a viable tissue if within the narrow normal range, and indicates the presence of non-tissue or dead tissue if outside of this predetermined range.

Level-Based. Use of metabolically-stabilized or other levels of certain parameters, such as glucose or oxygen in tissue. Any suitable level-based parameter may be used which indicates the presence of a viable tissue if within the narrow normal range, and indicates the presence of non-tissue or dead tissue if outside of this predetermined range.

Electromagnetic Radiation. Any radiative wave that can interact with living tissue. Examples include but are not limited to: terahertz radiation, microwave, visible light, infrared light, ultraviolet light, and MRI radio waves.

Electromagnetic Coupling or Optical Coupling. Electromagnetic coupling is an arrangement of an electromagnetic emitter (or detector) in such a way that radiation from the emitter (or detector) is transmitted to (or detected from) the tissue. When light is used, this can also be called “optical coupling.”

Imaging. The determination of a parameter of a region of space in at least zero dimensions. An example of a zero dimension scan is the use of more than one point measurements on the surface of the scalp, in order to determine the oxygenation of a specific deeper portion of the brain, such as the gray matter, at one point in space or over one region in space. A one dimensional scan could be the display of the presence of a certain tissue type, such as glandular tissue in the uterine wall, as a function of depth. Two-D and 3-D scans are standard radiological views, and are well-known. A 4-D scan could include the three spatial dimensions (x, y, z), as well as time t, such as the concentration of oxyhemolgobin which varies as the heart beats and blood pressure pulses between more oxygenated values shortly after the heart beat pulse arrives and less oxygenated values as the blood slows and blood pressure falls between heart beats.

### DETAILED DESCRIPTION

One embodiment of the device will now be described. While one particular embodiment of the device of the present invention is shown, those of skill in the art will recognize that other arrangements are possible within the scope and spirit of the invention.

In one embodiment, the biometric device is broadly comprised of an electromagnetic or radiation source, a sensor, and a CPU or calculation unit. The electromagnetic source is configured to radiate a target region with electromagnetic radiation, and the radiation is selected to be absorbed by selected metabolites. The sensor is configured to detect radiation backscattered or reemitted from the target region onto the sensor wherein the detected radiation is representative of a signal related to absorbance of the radiation by the metabolites. The CPU or calculation unit is configured to generate an output signal based upon the detected radiation, the output signal being a function of any one or more of: the degree, presence, and/or absence of living or biological tissue within said target region.

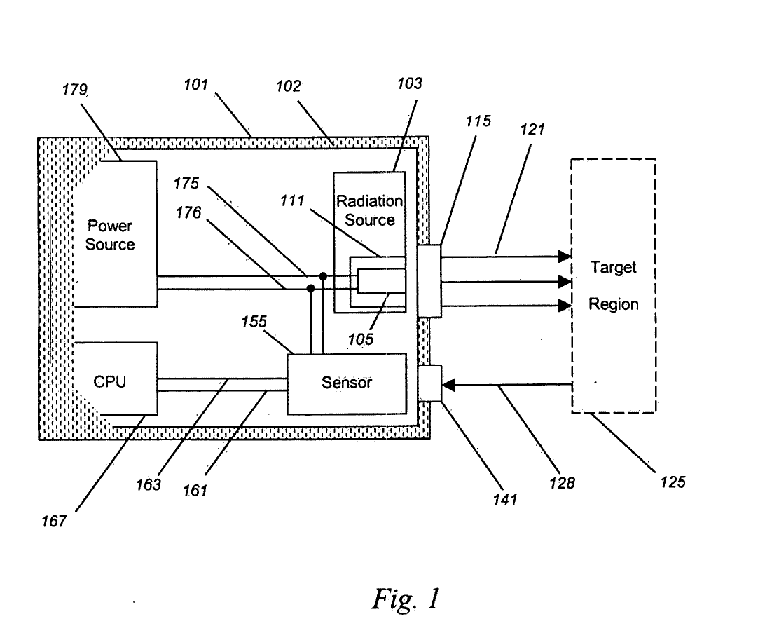

A cut-away schematic showing the interior of biometric device 101 according to an exemplary embodiment of the present invention is shown in FIG. 1. Device 101 is surrounded by exterior case 102. Portions of the interior components to device 101 may protrude as needed from this shell within the spirit of this invention, such as radiation source 103.

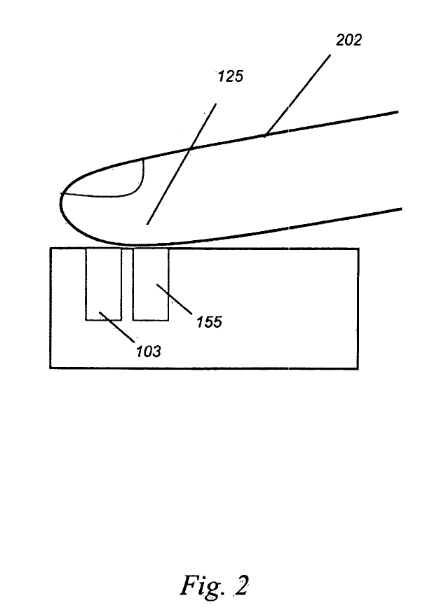

Within device 101, radiation source 103 is illustrated in its component parts. In this example, radiation source 103 is an optical system. While an optical system is shown and described herein, radiation source 103 can be comprised of other systems that emit electromagnetic radiation. Radiation source 103 is coupled to power source 179 via two electrical connections 175 and 176. In the exemplary embodiment radiation source 103 includes a high conversion-efficiency white LED source 105 (in this case, The LED Light, model T1-3/4-20W-a, Fallon, Nev.) which emits broad spectrum white light. LED source 105 is embedded into a plastic beam-shaping mount using optical clear epoxy 111 to allow light generated in LED source 105 to be collimated, thus remaining at a near-constant diameter after passing through optical window 115 to leave device 101. Light is then able to pass forward as shown by light path vectors 121, with at least a portion of this light optically coupled to target region 125. Note that while target region 125 may be in some instances a living tissue, the tissue itself is not considered to be a claimed part of this invention. One example of a target is shown schematically in FIG. 2 where target 125 is finger 202. However, the target could be more distant, such as a non-contact imaging of the oxygenation of the retina, or performed at a depth, such as the imaging or detection of oxygenation of the blood in the bone marrow deep in the leg.

Referring again to FIG. 1, a portion of the optical radiation reaching target 125, shown as emitted radiation 121, is backscattered and returns to device 101, as shown by light path vectors 128, to collection window 141. Collection window 141 in this embodiment is comprised of a glass, plastic, or quartz window, but can alternatively merely be an aperture or even a lens, as appropriate. As light passes through collection window 141 it then strikes sensor 155, where it is sensed and detected.

In some embodiments, sensor 155 includes one or more detectors. In one example, sensor 155 is comprised of a number of discrete detectors configured to be wavelength-sensitive. Alternatively, sensor 155 is comprised of a CCD spectrometer, with entry of light by wavelength controlled by gratings, filters, or wavelength-specific optical fibers. In any event, sensor 155 in this embodiment transmits a signal related to the detected light backscattered from target 125, producing an electrical signal sent via wires 161 and 163 to CPU or calculation unit 167. In general, CPU 167 is configured to analyze the signal related to the detected light backscattered from target 125, and to determine a metabolic signal which is function of any one or more of: the degree, presence, and/or absence of living or biological tissue of target 125. An example of such a determination is the determination of the oxygenation of the blood in tissue. Here, the metabolic signal is a ratio of oxyhemoglobin to total hemoglobin, a balance that has a value of 70%±4% in many normal tissues. Calculation of this ratio is described in detail below in the Examples. Alternatively, the signal could be a biochemical level, such as the level of glucose in the arterial blood, with the arterial blood being isolated in the analysis by pulse oximetry, a technique well known to those skilled in the art, in which the variable, pulsing (AC) signal is isolated from the static signal (DC) from all other tissues, thus allowing analysis only of the pulsatile component arterial blood in living tissue. Other ratios, levels, and calculations may be used to produce this metabolic signal as would reasonably occur to one skilled in metabolism and physiology, as described below.

Operation of the device may now be described. In some embodiments, device 101 is placed at a controlled access site, for example along with a fingerprint detector on a secure door. The device may measure the target directly, or it can be placed at a distance of many meters away. In the latter case, vectors 121 are free-space coupled to the target sufficient for optical coupling. Alternatively, this system could be embedded in a secure door entry, a kiosk, or other secure system.

In this example, device 101 is normally powered down and in a resting (off) state. At some point, it is desired to test the target for metabolic ratio, such as when a finger 202 is placed on device 101. Device 101 power ups and turns on when the sensor 155 is activated, in this case when the sensor 155 senses the presence of finger 202. Radiation source 103 begins to illuminate target 125, in this case finger 202, as shown by emitted radiation 121. In this embodiment, sensor 155 is comprised of an embedded spectrophotometer, such as a grating or prism-coupled CCD. One exemplary detector is a spectrometer (e.g., Ocean Optics SD2000, Ocean Optics, Florida, USA). The spectrometer receives backscattered light, and resolves the incoming light by wavelength. Resolving the incoming light by wavelength allows determination of the oxygenation of the tissue, such as is disclosed in US 2007/0027371, which is a marker of healthy tissue as well as of ischemia, an absence of insufficient blood flow to maintain life, which is a suitable functional parameter that indicates normal metabolic activity The result of this determination is sent to CPU 167, which can perform a ratio-based analysis (e.g., the relative oxygenation of hemoglobin compared to total hemoglobin), a level-based analysis (the presence of normal, pulsing levels of total hemoglobin in the tissue), or other biochemical or metabolism measurements, using known numerical recipes and software to determine whether the target 125 is alive or dead. For example, targets with tissue oxygenation ratios (oxygenated to total hemoglobin) above 85% are probably model systems with free blood exposed to oxygen, while values under 50% are likely dead tissue, while only values in the 50%-85% are likely to be stable, living tissues.

Once the measurement is completed, device 101 may power down and returns to a resting state, in order to save wear on the light source and conserve power

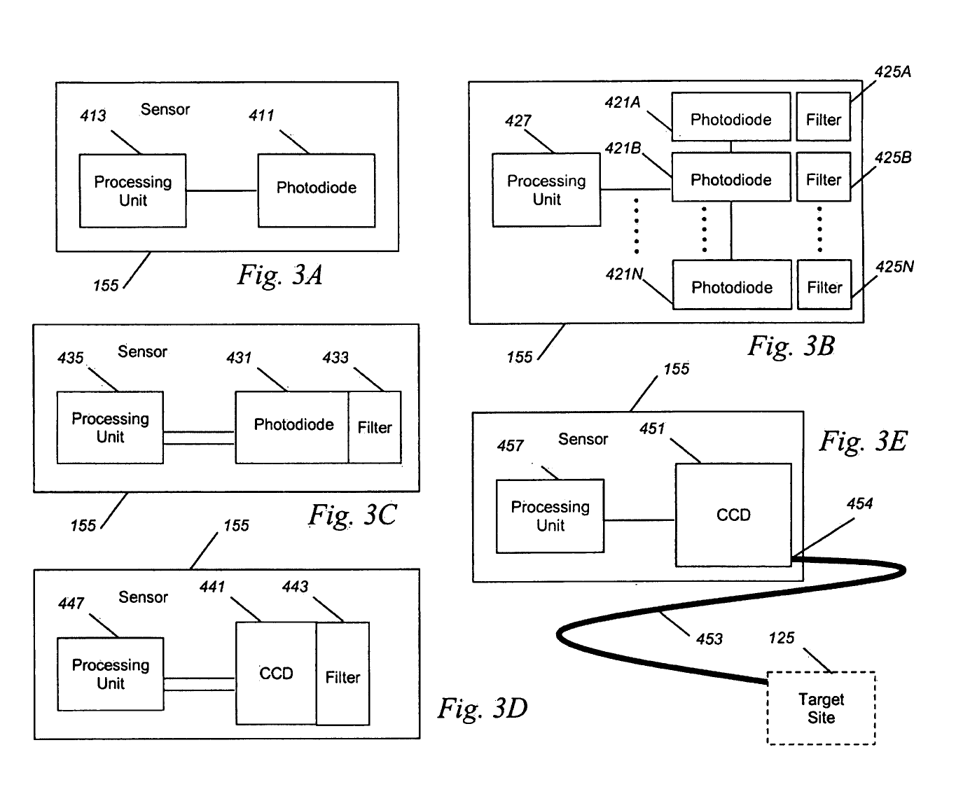

As described, above electromagnetic radiation sensor 155 may include one or more detectors. Sensor 155 may be comprised of a variety of alternative arrangements, for example and without limitation, as shown in FIGS. 3A-3E. In one embodiment illustrated in FIG. 3A, sensor 155 is comprised of a single photodiode 411 and processing electronics 413. In this example photodiode 411 is configured to be wavelength sensitive through the design of LED 105 as a cluster of LEDs of different wavelengths, each emitting at a different time or modulation frequency to allow decoding of the illuminating wavelength by photodiode 411 and processing unit electronics 413. Alternatively, as shown in shown in FIG. 3B, sensor 155 may comprise a set of different photodiodes 421A through 421N, each with filters 425A through 425N, allowing each photodiode to be sensitive to only one wavelength range, again allowing decoding of the sensed light by wavelength by processing electronics 427. Or, as depicted in FIG. 3C, sensor 155 is comprised of a single photodiode 431 with electronically variable filter 433, such as the Varispec filter from Cambridge Research Inc, and allowing the wavelength transmitted to be selected and processed by processing electronics 435.

In another configuration, shown in FIG. 3D, sensor 155 is comprised of CCD chip 441 with filter window 443 that varies over its length, allowing only certain wavelengths to reach each portion of CCD 441, allowing decoding of the illuminating wavelength by spectrophotometer processing electronics 447.

Finally, in a preferred embodiment, shown in FIG. 3E, sensor 155 comprises CCD chip 451 with optical fibers 453 attached to CCD 451 in a linear array. Fibers 453 are manufactured such that each fiber has a different interference coating on end 454, allowing each fiber to transmit a different narrow wavelength range, allowing decoding of the illuminating wavelength by processing electronics 457. Fibers 453 are biocompatible and can extend outside of device case 102, allowing device 101 to be placed remotely the target to be monitored, and for the free end of fibers 453 to be placed in proximity to target 125, where target 125 is not a part of the invention but rather an external site provided for the purposes of illustration. While specific examples are shown, those of skill in the art will recognize that the invention is not limited by the specific examples described herein, but that other arrangements are possible given the teaching of the present invention.

In another aspect, the present invention provides a security system including metabolism or biochemical based sensors configured to perform real-time analysis to distinguish between real and spoofed or dead tissue. In some embodiments, the security system is further configured to identify a specific individual.

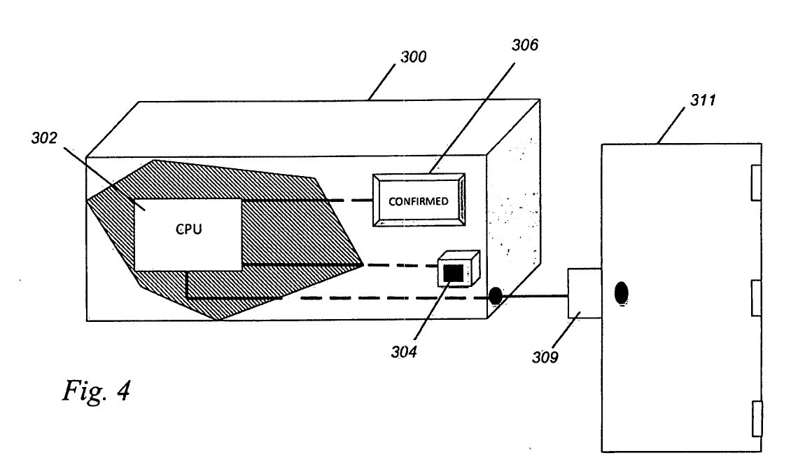

Referring to FIG. 4 one example of security system 300 is illustrated. Generally, security system 300 comprises a microprocessor 302, seen through a cutaway in system 300, subject interface 304 and display 306, and one more devices 101 having metabolism and/or biochemical based sensors 155 as described above. System 300 may be housed in a kiosk or embedded into a secure door lock or controlled-entry system, such as entry lock 309 for door 311, and the like, or housed in other systems as could be designed and built by one skilled in the art of controlled entry devices. Subject interface 304 is configured to interact with a subject for testing of the metabolism ratio and/or biochemical level of the subject, and may comprise any suitable detector, such as the finger detector shown in FIG. 2. Other suitable detectors include any device capable of sensing tissue, such as a retinal imager, or an infrared imaging scanner. Microprocessor 302 is configured to perform real-time analysis to distinguish between real and spoofed (or dead) tissue, or alternatively is configured to identify the subject and provide recognition (or lack thereof) of a particular individual. In the instance where the system identifies a particular subject, microprocessor 302 includes a database or memory device and the biometric data obtained by device 101 and sensors 155 is compared to data stored with the database or memory device. While one particular embodiment is show, those of skill in the art will recognize that other specific embodiments are possible within the spirit and scope of the invention.

### EXAMPLES

The breadth of uses of the present invention are best understood by illustrative examples, several of which are provided below. These examples are not intended to be limiting, nor are they intended to be inclusive of all possible uses and applications of the apparatus, but merely to serve as case studies by which a person, skilled in the art, can better appreciate the methods of utilizing, and the scope of, the device of the present invention.

### Example 1

### Determination of Sample as Living or Dead Using Hemoglobin Saturation Ratios

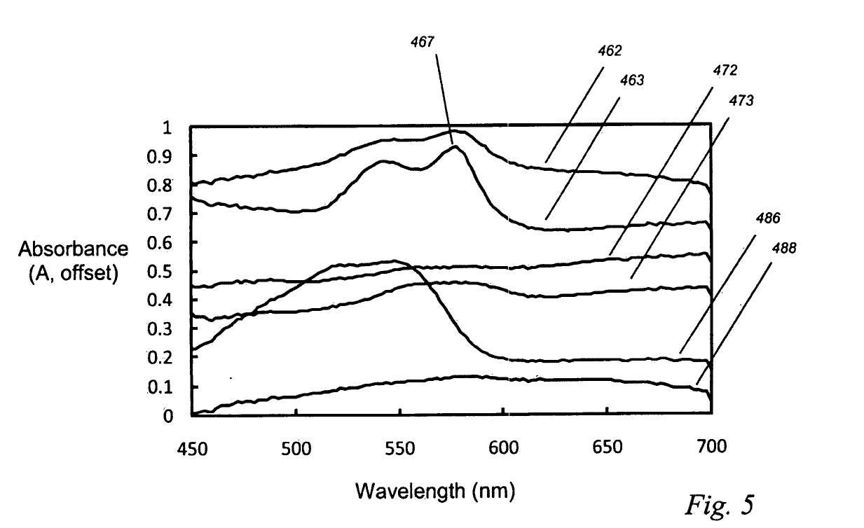

In this example, which reports data from an actual experiment performed on real and sham tissues, different samples were measured using a device constructed in accordance with embodiments of the invention as shown in FIG. 1. Light was collected from one emitter and detector pair, where the emitter was the raditional source of the visible light, and the detector is the radiation sensor. Optical spectra collected from several objects are shown in FIG. 5, offset along the absorbance axis for clarity. There are distinct differences in spectra between each sample shown. Living tissue spectra 462 and 463, for example, show hemoglobin peak 467, not a significant feature of the same tissues after death, respectively dead tissue spectra 472 and 473. When there is non-tissue, such as flesh-colored paper measured, paper spectrum 486 clearly lacks the expected hemoglobin peak 467. When a latex-glove is placed over finger 202, glove spectrum 488 is seen.

These differences in hemoglobin saturation, a ratio of oxygenated to total hemoglobin, allow for discrimination between the tissue type as alive or dead or a sham, and several algorithms can be selected to classify the tissue. In one embodiment, both ratio and levels are used in an algorithm comprised of the following steps:

a) determine the levels of oxy- and deoxy-hemoglobin in the tissue;

b) If the fractional ratio of the saturation of hemoglobin with oxygen to total hemoglobin in the tissue is determined to be between 60-80%, then the tissue is alive. Otherwise, the tissue is a sham; and,

c) If the total hemoglobin, level content is less than 10 micromolar then the tissue a sham. If the total hemoglobin content is greater than 200 micromolar then the tissue is a tube of blood. If the total hemoglobin is between 10-200 micromolar, then the tissue has the correct blood content.

This method illustrates use of the entire collected spectrum in order to perform differential spectroscopy to calculate saturation; however the full spectrum is not required, and it may be advantageous under certain conditions to use only certain regions of the detected spectrum. One may also consider using multiple ranges, such as when using a hemoglobin and fat/water ratios, with hemoglobin ratios well measured in many regions of the spectrum (e.g., 500-600 nm), while fat and water are best measured in the infrared bands (for example, from 900-1000 nm). The classification is performed by CPU 167 having computer-based spectroscopy analyzer software available in the art. A less complex algorithm could be envisioned as well, such as the ratio of differential absorbance at two wavelengths, for example at 675 nm and 800 nm, where the ratio of absorbance at 675 nm over 800 nm, a measure that is influenced by hemoglobin oxygenation, is used.

Using the spectra of FIG. 5, and other spectra (raw data not shown) the following results table is generated using the hemoglobin saturation ratio classification algorithm alone, as described above:

TABLE 1
Live versus Sham Determination Using Saturation

| Sample | Material | Saturation | Live or Sham? |
|---|---|---|---|
| 1 | Exposed Blood | 99% | Sham |
| 2 | Latex Fingertip | No signal | Sham |
| 3 | Tissue 1 (live) | 66% | Live |
| 4 | Tissue 2 (live) | 71% | Live |
| 5 | Tissue 1 (dead) | 0% | Sham |
| 6 | Tissue 2 (dead) | 0% | Sham |
| 7 | Pink Paper | No signal | Sham |

### Example 2

### Determination of Sample as Real or Sham Using Total Hemoglobin

Data from the experiment of Example 1, above, can be analyzed in a different manner. In this experiment, the determination is whether or not the tissue has intermediates normally present and balanced in tissue, in other words tissue in metabolic equilibrium. In this case, the measure is a level-based one based on a biochemical level, rather than a ratio-based one based on metabolic equilibrium. In this embodiment, an algorithm is comprised of the following steps:

a) determine the level of oxy and deoxy hemoglobin, sum to a total

b) If total blood content (tHb) is between 10 and 200 uM, then the tissue is real. Otherwise, the tissue is sham.

Using this algorithm, the determination is as follows:

TABLE 2
Real versus Sham Determination

| Sample | Material | tHb (uM) | Real or Sham? |
|---|---|---|---|
| 1 | Exposed Blood | 900 | Sham |
| 2 | Latex Fingertip | 1 | Sham |
| 3 | Tissue 1 (live) | 56 | Real |
| 4 | Tissue 2 (live) | 68 | Real |
| 5 | Tissue 1 (dead) | 41 | Real |
| 6 | Tissue 2 (dead) | 14 | Sham |
| 7 | Pink Paper | 0 | Sham |

Note that in the above example, the tissue with the tourniquet has no blood flow, and so is on its way to dying if the tourniquet is retained in place for minutes to hours. In Example 1, the tissue was determined to be dead, whereas in this example the finger is correctly identified as real vs. not real. A combination of live and real determinations, that is a combination of the determinations of Example 1 and this example, may yield an even more reliable biometric measure using the same optical data as analyzed by the CPU.

Providing hemoglobin in a bottle, to attempt to spoof normal ratios, would be difficult using these algorithms. Exposure of free blood to air drives the oxygenation to 100% within seconds, while deoxygenated samples are difficult to keep at anything but 0% saturation due to the metabolism of free oxygen by bacteria. Further, hemoglobin degrades over time, and produces methemoglobin, which is cleared by the body in a living animal, but is not cleared in the test tube, and therefore accumulates over time. Therefore, creating a 70% sample and keeping the sample at this level with normally low levels of methemoglobin, long enough to attempt to fool the biometric determination, is very difficult to achieve in non-living systems.

### Example 3

### Determination of Sample as Real or Sham Using NMR

Just as oxy and deoxy hemoglobin are kept in balance, with about 70% oxygenated hemoglobin and 30% deoxygenated hemoglobin in normal tissue, so are many intermediates that can be measured by NMR, and its medical imaging equivalent MRI, also kept at steady levels, or with steady ratios of various-components.

For example, in living tissue, the phosphorous spectrum can be measured using NMR or MRI. In the living body, inorganic phosphate (Pi) is incorporated into adenosine Triphosphate (ATP) or Phosphocreatine (PCr), both energy storage substances. In dead tissue, ATP, and its related substances ADP and AMP degrade to Adenosine and inorganic phosphate (Pi). Because of the interaction of the pools of PCr, ATP, and Pi, the levels are maintained in vivo in a narrow range of an energy-requiring equilibrium. In healthy, living tissue, the level of Pi is minimized using energy derived from food and oxygen, while in dead (or dying) tissue, ATP and PCr are rapidly depleted and converted to Pi within minutes. Therefore the presence of a normal ATP/Pi ratio, of a normal PCr/Pi ratio, or normal and low Pi levels, are each an indication of normal, healthy, living tissue, whereas high or low ratios or levels are signs that something is metabolically amiss, such as a falsified or sham tissue.

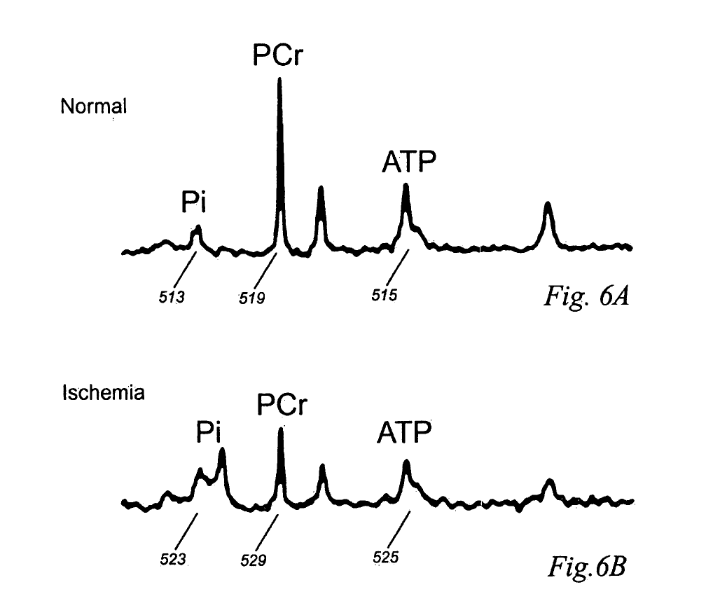

Two examples of these markers in actual 3 l-Phosphorous NMR spectra of tissue are shown in FIGS. 6A and 6B. The height of each peak (or more precisely, the area under each peak) corresponds to the relative concentration of each phosphorus-containing metabolite in the tissue sample. Normal tissue is shown in the NMR spectrum of FIG. 6A. Here Pi Peak 513, ATP peak 515, and PCr peak 519, are present in standard levels and ratios in normal tissues. In this case, ATP is at an intermediate level, Pi is relatively low, and PCr is relatively high, such that the ATP/Pi area ratio is about 3:1 and the PCr/Pi area ratio is about 9:1. These levels and ratios are indicative of real living tissue. In contrast, these levels and ratios change during death or ischemia, as shown in FIG. 5B. Here Pi Peak 523 rises, while ATP peak 525 and PCr peak 529 both fall. This yields an ATP/Pi ratio of only 0.6 (compared to 3:1 in normal tissue) and a PCr/Pi ratio of about 1.4:1 (compared to 9:1 in normal tissue), a substantial fall in each ratio that could be used to differentiate living from dead tissue.

Other markers exist in the 1-Hydrogen NMR spectrum. The presence of citrate and lactate, both biological intermediates containing hydrogen, can be measured and compared to more stable cell wall components, such as choline, which does not change rapidly during metabolic stresses. These levels and ratios can be determined and compared to ratio and total level standards for living and deceased tissues.

Of note, miniaturized surface NMR sensors have been developed for the quantitation of certain chemicals, such as tire rubber, for industrial use. In another embodiment of the present invention, NMR sensor is configured to be tissue compatible and is provided as a component in biometric device 101.

These NMR measures are easily constructed as an image, and MRI imaging using NMR data is a well known technique. For one skilled in the art of medical imaging, the generation of images using optical, electromagnetic data, or NMR/MRI data is a natural progression. Then, the ratios and level algorithms may be applied to the entire image, to regions of interest, or to a single point, in order to produce a live dead, real or sham, or other anti-spoofing measure as an image in zero or more dimensions by applying the algorithms taught in the present invention to the data in the images.

In addition to these examples, various other modifications may be made within the spirit of this invention by those skilled in the art, and no undue limitation is to be implied of inferred from an omission of these items from the above description, and in the following disclosure. While the above disclosure has described one embodiment, it will be apparent to those skilled in the art that various changes and modifications may be made wherein, without departing from the spirit of the present invention. It is therefore state that such changes and modifications all fall within the true spirit and scope of the invention.

We have discovered an improved apparatus and method that measures tissue and allows the detection, quantification, localization, or characterization of one or more tissues as living vs. dead, and/or real vs. fake using metabolic and biochemical levels or ratios within the observation field of the instrument, either as a measurement or as an image. The device has been built and experimentally tested in several configurations, and has immediate application to several important problems, both medical and industrial, and thus constitutes an important advance in the art.

What is claimed:

1. A metabolism-sensitive or biochemical-level-sensitive device comprising: an electromagnetic source for radiating a target region with electromagnetic radiation, said radiation selected to be absorbed by selected metabolites or biochemical components; a sensor configured to detect radiation backscattered or reemitted from said target region onto said sensor wherein said detected radiation preserves a signal related to said absorbance by said metabolites or biochemical components; and a calculation unit configured to generate, based upon said detected radiation, an output signal that is a function of the degree, presence, or absence of living or biological tissue within said target region.

2. The device of claim 1, wherein said radiation source is a broadband white LED.

3. The device of claim 1, wherein said radiation sensor is a CCD arranged so as to be wavelength sensitive.

4. The device of claim 1, wherein said determined output signal is configured to be a function of tissue hemoglobin or myoglobin saturation.

5. The device of claim 1, wherein said radiation source is an MRI field, and said radiation detector is an MRI coil.

6. The device of claim 1, wherein said radiation source is an NMR field, and said radiation detector is an NMR coil.

7. The device of claim 1, wherein said sensor further comprises a non-metabolism, non-biochemical-based biometric sensor, and wherein said output signal is a function both of said degree, presence, or absence of said living tissue, and of said non-metabolism, non-biochemical-based biometric sensor.

8. The device of claim 7, wherein said non-metabolism-based biometric sensor is a fingerprint sensor.

9. The device of claim 7, wherein said non-metabolism-based biometric sensor is a retinal-vessel sensor.

10. A method of differentiating living metabolizing tissue from nonliving or sham tissue, comprising the steps of:
radiating a target region with electromagnetic radiation from an electromagnetic source;
detecting radiation backscattered or reemitted from the target region; and
determining, based upon the said detected radiation, a presence or absence of living tissue within the target region.

11. The method of claim 10 further including the steps of:
performing a non-metabolism-based biometric identification; and
determining a positive or negative biometric identification match based upon both the presence or absence of living tissue and the non-metabolism-based identification.

12. A biometric device for distinguishing between living and dead tissue, characterized in that: selected metabolites or biochemical components in said tissue are detected and analyzed to determine whether the tissue is living or dead.

13. A biometric device for distinguishing between real and sham tissue, characterized in that: selected metabolites or biochemical components in said tissue are detected and analyzed to determine whether the tissue is living or dead.

14. A security system for controlling access to an area, comprising:
a subject interface;
one or more devices comprising: an electromagnetic source for radiating a target region of a subject with electromagnetic radiation, said radiation selected to be absorbed by selected metabolites or biochemical components; and one or more sensors configured to detect radiation backscattered or reemitted from said target region onto said sensor wherein said detected radiation preserves a signal related to said absorbance by said metabolites or biochemical components; and
a microprocessor configured to analyze said signal and based upon said analysis to permit or deny access to said area.

15. The system of claim 14, wherein said radiation source is a broadband white LED.

16. The system of claim 14, wherein said radiation sensor is a CCD arranged so as to be wavelength sensitive.

17. The system of claim 14, wherein said signal is configured to be a function of at least one of tissue hemoglobin, hemoglobin saturation, myoglobin content, fat content, water content; or myoglobin saturation.

18. The system of claim 14, wherein said radiation source is an MRI field, and said radiation detector is an MRI coil.

19. The system of claim 14, wherein said radiation source is an NMR field, and said radiation detector is an NMR coil.
